(19) United States
(12) Patent Application Publication
(10) Pub. No.: US 2010/0054570 A1
(43) Pub. Date: Mar. 4, 2010

(54) MOTION CORRECTED MULTINUCLEAR MAGNETIC RESONANCE IMAGING

(75) Inventors: Rudolf Mathias Johannes Nicolaas Lamerichs, Eindhoven (NL); Frederik Jan De Bruijn, Eindhoven (NL); Holger Gruell, Eindhoven (NL); Jochen Keupp, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/595,252

(22) PCT Filed: Apr. 9, 2008
(86) PCT No.: PCT/IB08/51349

§ 371 Date: Oct. 9, 2009

(30) Foreign Application Priority Data
Apr. 12, 2007 (EP) 07105997.6

(51) Int. Cl. G06K 9/00

(52) U.S. Cl. 382/131

(57) ABSTRACT

The invention relates to a method for acquiring MR images (200-216) of an object, said object comprising at least first and second kinds of nuclei, the method comprising: acquiring (300; 304) first MR image data (200; 202; 204) of the object, wherein the first nuclei are excited, acquiring (302) second MR image data (206-216) of the object, wherein the second nuclei are excited, analyzing the first MR image data (200; 202; 204) determining motion parameters describing a motion of the object based on said analysis, motion correcting the first and/or second MR image data (206-216) using said motion parameters.

### TECHNICAL FIELD

The invention relates to a method for acquiring Magnetic resonance (MR) images of an object, a magnetic resonance imaging apparatus for acquiring MR images of an object and a computer program product comprising computer executable instructions.

### BACKGROUND AND RELATED ART

Magnetic resonance imaging (MRI) is one of the major imaging techniques in medicine. MRI is capable of generating detailed images of soft tissues. In MRI, specific properties of the various compounds found inside tissues are used to generate images, e.g., water is most commonly used for this purpose. When subjected to a strong external magnetic field, the protons ¹H will align with this external field, resulting in a net magnetic moment. After excitation by radio frequency RF pulses, this magnetization will generate an RF signal that can be detected. This RF signal is characterized by a frequency that is related to the magnetic field strength. Therefore, magnetic field gradients are used to encode the spatial information which is needed to reconstruct an image from detected signals.

In situations, when the tissue contrast is insufficient to obtain satisfactory clinical information, artificial contrast agents are used. Some contrast agents possess permanent magnetic dipoles, which influence the relaxation process of the nearby water protons and so lead to a local change of the image contrast. Other agents contain nuclei of species, which do not naturally occur in the human body, e.g., fluorine, indicated by the symbol of the natural isotope ¹⁹F. In this case, if data acquisition is performed on said specific nuclei, the only detectable signal will stem from the added (fluorine) agent and not from the surrounding tissue.

The total absence of the proton tissue signal in the fluorine MRI data makes this imaging method particularly suitable for targeted molecular imaging, where targeted contrast agents (tCAs) are composed to bind to specific biomarkers in the body. These biomarkers are selected based on their specificity for certain diseases and thus, contain valuable diagnostic information. Examples of such biomarkers are αᵥβ₃, a receptor protein up-regulated in angiogenesis.

In general tCAs are composed of a core, which serves as a carrier, and ligands, which are attached to the core. Ligands are particularly antibodies or fragments thereof. The core itself typically contains high amounts of fluorine atoms. This can be e.g. an emulsion of a fluorine compound, or a polymer capsule filled with a perfluoro-compound. However, in general, the concentration of the biomarkers will be very low. This low molar concentration causes the ¹⁹F MR signal to be low, relative to the ¹H signal. High resolution imaging of the ¹⁹F signal is possible but this requires averaging of the ¹⁹F signal in order to increase the signal to noise ratio (SNR). Averaging requires multiple acquisitions, hence extra acquisition time. Additionally, isometric molecules like perfluorocarbons exhibit a large chemical shift, which must be corrected to obtain an optimal SNR and unambiguous results. Therefore, chemical-shift corrected acquisition and related spectroscopic MRI methods have to be applied, which is additionally generally rather time consuming.

Various methods and systems for magnetic resonance imaging of multiple nuclei have been proposed previously. For example EP 0 498 539 B1 discloses a magnetic resonance apparatus for concurrent imaging or spectroscopic analysis of hydrogen and phosphorous nuclei, which is also applicable to other multiple nuclei imaging spectroscopy applications. WO 2005/106518 A1 discloses a magnetic resonance imaging apparatus which is capable to perform magnetic resonance imaging at several RF frequencies. Other magnetic resonance imaging apparatus relating to the same subject matter are disclosed in EP 758 751, EP 0 955 554 B1 and WO 2005/106519.

However, since acquisition of MR image data typically consists of multiple MRI measurements for the purpose of averaging MRI signals to increase the signal to noise ratio, it has to be ensured that during the measurements the image is not compromised by physiologic motion or deformation, since the set of measurements taken at different states of the object would not be immediately comparable. Object motion during the acquisition of MR data produces image artifacts like blurring or ghosts in the phase encoded direction.

The reason for object motion in MRI may thereby be manifold. One example is the periodic motion of the heart, or the breathing motion of the lungs.

A possibility to circumvent the problem of MR image distortion due to the motion of imaged objects is motion correction in MRI. Motion correction for MRI exists in many forms. In the case of a periodic movement, motion estimation can be done by monitoring the movement with an external device and acquiring the signal always at the same time related to the movement. Cardiac motion is a typical example for this type of motion. In the case of a translational motion, typically respiratory motion, estimation is based on measuring the position of a diaphragm through a pencil shaped volume, called the navigator, which is acquired in addition to the normal MR image data. Compensation is generally based on the rigid translation or affine transformation of the surrounding anatomical data. An example for reducing motion artifacts in magnetic resonance imaging can be found in U.S. Pat. No. 7,127,092 and U.S. Pat. No. 6,888,915.

However, in case the tissue motion is irregular over time and complex throughout the volume, the traditional methods for motion estimation and correction fail. Such irregular and complex motion typically takes place in the bowel. Even after correction of respiration, the peristaltic motion of the small intestine causes complex displacement patterns by pushing against neighboring intestinal segments against the colon. Although, the colon itself exhibits peristaltic motion as well, its repeated local contractions appear in an irregular pattern, which are therefore unpredictable. Chemical immobilization of the intestines, for example using an injection of Buscopan is only effective during a relatively short time span which is generally sufficient for CT yet insufficient for MRI.

### SUMMARY OF THE INVENTION

The invention aims at solving this problem by using simultaneous or interleaved acquisition of proton images and other nuclei, e.g. ¹³C, ¹⁹F or ³¹P images. The ¹H images, which are highly sensitive to quickly detect physiological motion, can thereby be used to calculate a motion correction.

The present invention provides a method for acquiring MR images of an object, said object comprising at least first and second kinds of nuclei, the method comprising acquiring first MR image data of the object, wherein the first nuclei are excited. Concurrently or in the next step, second MR image data are acquired of the object, wherein the second nuclei are excited. The first MR image data are analyzed and motion parameters describing a motion of the object are determined based on said analysis. Finally a motion correction of the first and/or second MR image data is performed using said motion parameters. After the correction, multiple images resulting from the corrected second MR image data can be added to increase the signal to noise ratio. By performing the method according to the invention, second MR image data of the object can be acquired with a good signal to noise ratio.

This is especially important in the case of targeted contrast agents, which make this method especially suitable for the detection of certain diseases. For example, cancer cells can be detected by ¹⁹F labelled antibodies which specifically bind to said cancer cells. After injection into the human body, the fluorine labelled antibodies are more or less homogenously distributed in the human body. In the case of acquiring ¹⁹F MR image data, only a homogenous background (noise) signal originating from said homogenously distributed ¹⁹F labelled antibodies will be visible in the respective MR images. However, in the presence of respective cancer cells, the antibodies may bind to said cancer cells and accumulate at those cancer cell areas in the body. This leads to an accumulation of fluorine atoms at said locations, which can be easily detected in respective ¹⁹F MR images since due to the high concentration of fluorine atoms these areas light up as bright spots in the images. Using the image acquisition according to the invention, ¹⁹F MR image data acquisition can be performed over a long time scale, since any disturbing motion of the tissue is compensated.

In the case of targeted contrast agents, the method is expected to perform even better if the agent also contains an entity that affects the contrast in the ¹H image, e.g., Gadolinium based contrast agents could be used for this purpose.

In general, magnetic resonance imaging based on multiple nuclei is only meaningful in case the acquired image data can be related to the internal structure of the tissue under investigation. The anatomical information is thereby typically revealed by traditional MRI on the basis of the ¹H nuclei. Since this requires a proper spatial correspondence of the ¹H data and the data of the second kind of imaged nuclei, any tissue motion has to be avoided. However, by applying the method according to the invention a proper spatial correspondence of the proton data and the image data of the imaged nuclei can be achieved even in the presence of tissue motion.

In accordance with an embodiment of the invention, the excitation of the first and second nuclei is performed simultaneously. Alternatively, the excitation of the first nuclei is performed alternating with the excitation of the second nuclei. The first alternative offers the advantage of detecting motion without additional scan time. However, the second alternative is considered as the preferred data acquisition method, since this allows the acquisition of the first MR image data using optimum apparatus measurement parameters and acquisition of the second MR image data also using respective optimum apparatus measurement parameters. Typically, the optimum apparatus measurement parameters are thereby different for different kinds of nuclei.

An example is the usage of fluorine compounds such as perfluorocarbons or perfluorooctylbromide (PFOB) also known as Perflubron™, which is an FDA approved ¹⁹F compound. Such fluoro compounds tend to exhibit a large chemical shift. Therefore, this requires a chemical-shift corrected acquisition, which is rather time consuming, such that a relatively large voxel size is necessary to keep the total imaging time within practical bounds. A voxel is thereby the 3D equivalent of a pixel. Acquiring high resolution images, i.e., with a relatively small voxel size would correspond to a large amount of data points, which all would have to be corrected from said chemical shift. Therewith, the overall data acquisition time would not be acceptable. The solution is to use a respective control sequence for the MR field gradients which enables to use a relatively large voxel size.

However, in contrary such a relatively large voxel size would make it rather difficult in the case of ¹H MR image data acquisition to accurately perform the motion tracking for motion correcting first and/or second MR image data. That means, that in case the excitation of the first and second nuclei is performed simultaneously those nuclei are subject to the same magnetic gradient at the same time instance with the temporal and spatial resolution of both datasets tightly being coupled. In case of simple, large scale motion patterns like translational motion in respiration, simultaneous acquisition of proton and other nuclei can be most efficient, because no extra measurement time is needed for the motion estimation. However, especially in case of complex motion, it is potentially difficult to meet both the spatial and temporal requirements discussed above. By performing the excitation of the first and second nuclei in an alternating or interleaved fashion, these problems can be circumvented and each data acquisition can be formed using respective optimum apparatus measurement parameters—e.g. a large voxel size for ¹⁹F imaging and a small voxel size for ¹H imaging.

In accordance with an embodiment of the invention, the motion parameters describe the motion of the object during the acquisition of the first and/or the second MR image data. Alternatively, the parameters describe an estimated motion of the object of the acquisition of the first and/the second MR image data. This allows to perform the method according to the invention in an interpolating or extrapolating manner.

In accordance with an embodiment of the invention, the method further comprises determining a quality measure, wherein the quality measure is a value describing the reliability of the determined motion parameters. Based on the quality measure, the acquisition time for acquiring the first MRI data is determined. This has the advantage, that an accurate motion detection is permanently ensured. The quality measure is formed by at least a single prior motion estimate. Thereby a global value for the entire estimate or a multidimensional distribution of quality measures are generated for each temporal instance. Optionally, the reference data from one or multiple temporal instances can also be used as basis for determining the quality measure.

In accordance with an embodiment of the invention, the first and/or the second MR image data is unidimensional or multidimensional MRI data. Acquiring the first MR image data comprises a first and a second data acquisition step, wherein the acquisition of the second MR image data is performed in between the first and the second data acquisition step. Thereby for example, the first MR image data acquired in the first acquisition step can be used to determine an appropriate motion correction which is applied to the second MR image data acquired in the second data acquisition step for the purpose of motion correction of the second MR image data.

In accordance with an embodiment of the invention, the motion correction of the first MR image data is performed relative to the object position at a first point in time and the motion correction of the second MR image data is performed relative to the object position at a second point in time, wherein the first and the second point in time are substantially identical. This is necessary, if an MR image obtained from the first corrected first MR image data has to be superimposed to an MR image obtained from the motion corrected second MR image data. Since in the extreme case the second MR image only shows a bright spot indicating accumulated respective nuclei in a specific area in the body, the superimposed first MR image can be used to spatially locate said area with respect to the imaged object.

In accordance with an embodiment of the invention, the first kinds of nuclei comprise ¹H nuclei and the second kinds of nuclei comprise e.g. ¹³C or ¹⁹F or ³¹P nuclei. The ¹H nuclei are thereby naturally present throughout the whole image study and due to the high MR sensitivity of ¹H nuclei it is easily possible to perform motion correction based on MR image data acquired from said ¹H nuclei. In contrary, the second kinds of nuclei can be used in combination with targeted contrast agents to effectively locate certain kinds of diseases, for example cancer cells.

In accordance with an embodiment of the invention, analyzing the first MR image data for determining the motion parameters describing a motion of the object is performed using a block-matching algorithm and/or a phase plane algorithm and/or an optical flow calculation algorithm. In general, any kind of method for reconstruction of an image of a moving object known from the prior art can be used to perform the method according to the invention. A block-matching algorithm may be a 3-dimensional recursive search (3DRS).

In accordance with an embodiment of the invention, acquiring of the first MR image data and/or acquiring of the second MR image data comprises multiple data acquisitions. Therewith, a high signal to noise ratio can be achieved.

In accordance with an embodiment of the invention, the acquisition of the first MR image data is performed using a first RF coil tuned to a first Larmor frequency corresponding to the first kinds of nuclei and wherein the acquisition of the second MR image data is performed using a second RF coil tuned to a second Larmor frequency corresponding to the second kinds of nuclei. Preferably, the acquisition of the first MR image data and acquisition of the second MR image data is performed using only one common first RF coil, wherein the first RF coil is tuneable to the first and the second Larmor frequency of the first and the second kinds of nuclei, respectively.

Furthermore, a dual resonant (or even multiple resonant) common first RF coil can be applied, which is able to acquire MR data from the first and second kind of nuclei at the same time, without the need of retuning between the acquisition of different nuclei. Therewith, any state of the art magnetic resonance apparatus can be used in order to perform the method according to the invention. Only certain amplifiers, filters and other hardware components have to be adapted in order to perform motion corrected multinuclear MR imaging.

In accordance with an embodiment of the invention, the method further comprises correcting a chemical shift of the first and/or second MR image data. This is necessary, since for example compared to ¹H MRI, ¹⁹F MRI manifests larger chemical shifts such that the peak splitting caused by the fluorine atoms is rather large and not easily recombined into a single signal. As “frequency” is used as an indication of position in MRI, this translates into ghosting of the image and therefore inaccurate positioning for MRI slide selection. A chemical-shift correction of the first and/or second MR image data circumvents this problem.

In a further aspect, the invention relates to a magnetic resonance imaging apparatus for acquiring MR images of an object, said object comprising at least first and second kinds of nuclei, the apparatus comprising components for acquiring first MR image data of the object, components for acquiring second MR image data of the object, components for analyzing the first MR image data, said components for analyzing the first MR image data being adapted for determining motion parameters describing a motion of the object and components for motion correcting the first and/or second MR image data using said motion parameters.

In accordance with an embodiment of the invention, the apparatus further comprises components for determining a quality measure, wherein the quality measure is a value describing the reliability of the determined parameters.

In accordance with an embodiment of the invention, the apparatus further comprises components for correcting a chemical shift of the first and/or second MR image data.

In accordance with an embodiment of the invention, the components for acquiring the first MR image data comprise a first RF coil being tuneable to a first Larmor frequency corresponding to the first kinds of nuclei and wherein the components for acquiring the second MR image data comprise a second RF coil being tuneable to a second Larmor frequency corresponding to the second kinds of nuclei.

In accordance with an embodiment of the invention, the components for acquiring the first MR image data and the components for acquiring the second MR image data comprise the first RF coil, whereby the first RF coil is tuneable to the first and the second Larmor frequency of the first and the second kinds of nuclei, respectively.

In accordance with an embodiment of the invention, the components for acquiring the first MR image data and the components for acquiring the second MR image data comprise the first RF coil, whereby the first RF coil is a dual-tuned coil, which is at the same time resonant at the first and the second Larmor frequency of the first and the second kinds of nuclei, respectively.

In another aspect, the invention relates to a computer program product comprising computer executable instructions for performing the method for acquiring MR images of an object according to the invention.

### BRIEF DESCRIPTION OF THE DRAWINGS

In the following preferred embodiments of the invention are described in greater detail by way of example only making reference to the drawings in which:

FIG. 1 is a block diagram of an embodiment of a magnetic resonance imaging apparatus,

FIG. 2 shows a block diagram illustrating a method of acquiring a motion correcting MR image data,

FIG. 3 shows a flowchart illustrating a method of motion correcting MR image data,

FIG. 4 shows a further detailed block diagram illustrating a system for motion correcting MR image data.

### DETAILED DESCRIPTION

In the following, similar elements are designated by the same reference numerals.

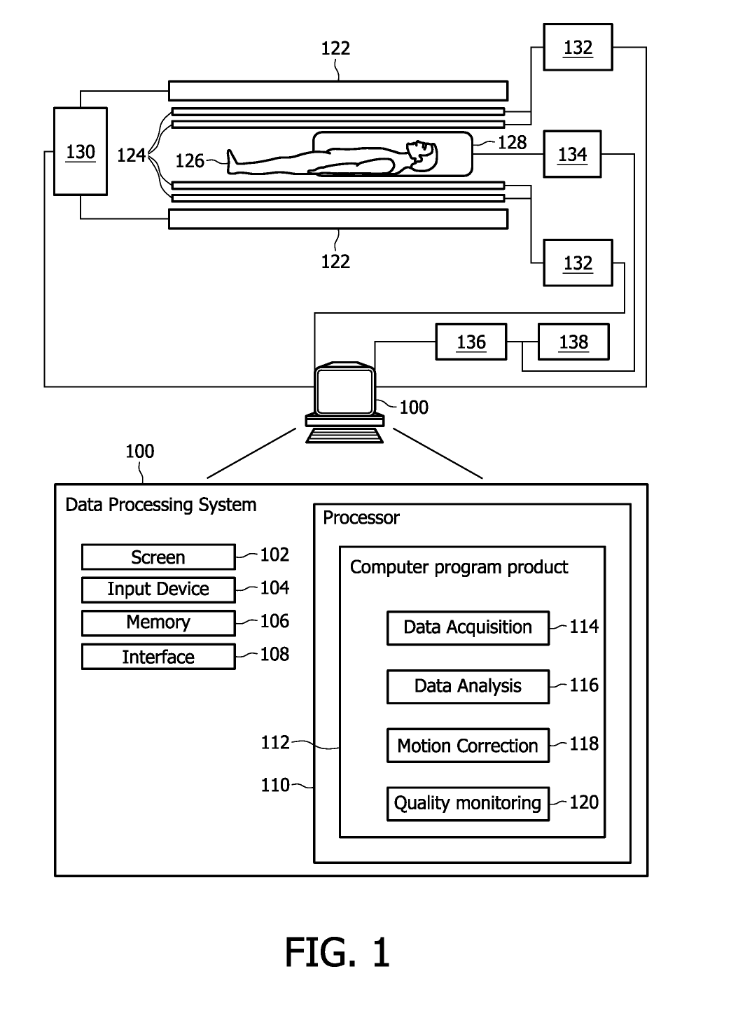

FIG. 1 is a block diagram of an embodiment of a magnetic resonance imaging apparatus. Thereby, only major components of a preferred MRI system which incorporates the present invention is shown in FIG. 1. The magnetic resonance imaging apparatus comprises a data processing system 100, whereby the data processing system 100 typically comprises a computer screen 102, an input device 104 which could for example be a keyboard and a mouse, as well as a memory 106 and an interface 108. Thereby, the interface 108 is adapted for communication and data exchange with typical MRI hardware components. These hardware components comprise for example a main field control unit 130 adapted for controlling the main field of the main magnet coils 122. The main magnets 122 may thereby be adapted as permanent super conducting magnets or being externally driven and switched on and off for each individual usage of the MRI system. The interface 108 further communicates with gradient coil control units 132, whereby the respective gradient coils 124 are preferably self shielded gradient coils for producing gradients along three mutual axis x, y and z. The MRI system further comprises an RF coil 128 electrically connected to an RF control unit 134. Using an RF generator 138, an RF pulse sequence is generated under the control of the data processing system 100 and therewith for example protons in the body 126 of a person are excited in a predefined manner. The resulting magnetic resonance signal is detected by the same RF coil 128 and transmitted to an amplifier 136, followed by processing of said RF signals by special hardware components like quadrature detectors, mixers etc. well known in the art. Thereby, such hardware components can be adapted as additional external hardware units or being implemented in the data processing system 100.

The data processing system 100 further comprises a processor 110 being adapted to execute computer executable instructions of a computer program product 112. In the present embodiment, the data processing system 100 comprises a computer program product 112 by means of a data acquisition module 114, which is adapted to control the hardware units 122-124 and 128-138. Data acquisition is performed and the acquired data is analyzed by a data analysis module 116. Another module 118 is further adapted for performing a motion correction based on said acquired data. Another module 120 is adapted to perform a quality monitoring in order to determine a quality measure of the reliability of the performed motion correction.

The motion estimation, motion compensation and motion-reliability assessment can be performed similar to the process of motion-compensated video-format conversion known as Natural Motion™.

The MRI system depicted in FIG. 1 is further adapted to perform multinuclear magnetic resonance imaging. Thereby, the RF coil 128 is tuneable to multiple resonance frequencies corresponding to the Larmor frequencies of the respective investigated nuclei, or the RF coil 128 is a multiple-tuned RF coil which is simultaneously resonant to the Larmor frequencies of the investigated nuclei, or the RF coil 128 is adapted as two individual or multiple individual RF coils, whereby each RF coil is tuneable to one of the respective Larmor frequencies of the investigated nuclei. Also, the RF coil control unit 134, the amplifier 136 and the RF generator 138, as well as necessary components to perform MR imaging can be adapted as multiple components, each component being adapted for a certain resonance frequency range. Alternatively, said components might be integrated into respective universal hardware components.

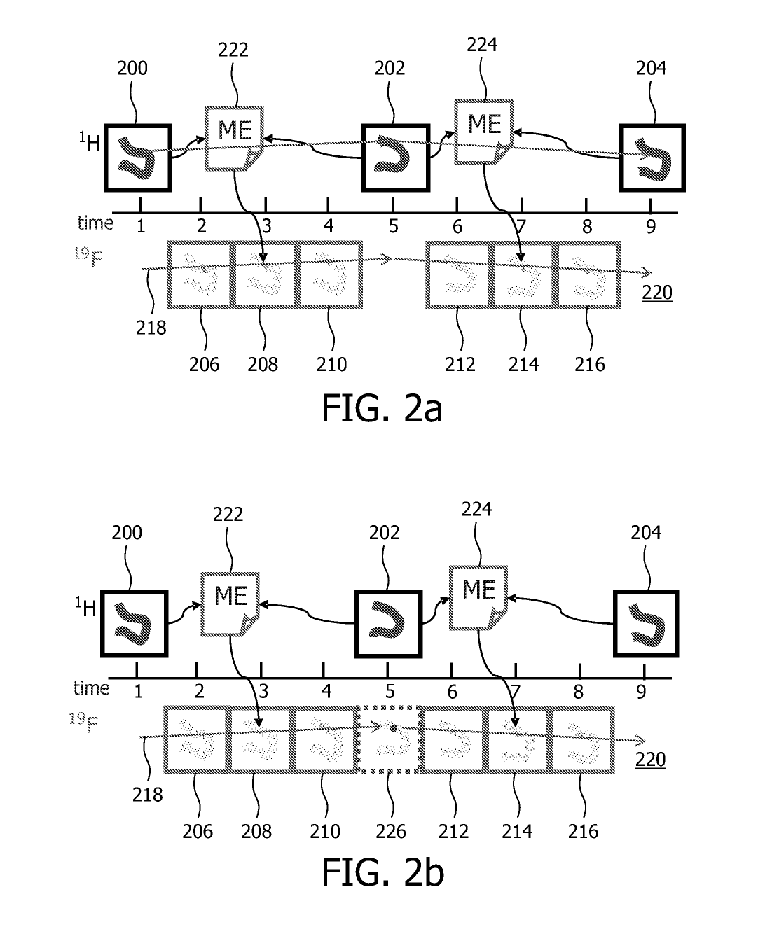

FIG. 2 shows a block diagram illustrating a method of acquiring motion corrected MR image data. In FIG. 2a a timescale is shown, whereby on top of the timescale pictograms 200, 202 and 204 of recorded ¹H MR images are shown and on the bottom ¹⁹F MR image pictograms 206-216 are shown, both acquired from the same area of interest of for example a human body. All images show a colon, exhibiting an unpredictable motion during the data acquisition process. The major difference between the ¹H images 200-204 and the ¹⁹F images 206-216 is, that the moving colon is not visible in the raw ¹⁹F data. In contrary, the moving colon is clearly imaged by the proton MRI but valuable diagnostic information is not contained in said images 200-204.

However, if targeted contrast agents labelled with high amounts of fluorine atoms are applied to the colon, this results in a specific binding of the targeted contrast agents to a certain area of the colon. Due to the high concentration of ¹⁹F atoms, said area is visible in the ¹⁹F images as a spot. However, the spot is hard to see in each individual image 206-216 due to the bad signal to noise ratio due to the low MR sensitivity and still low concentration of ¹⁹F atoms.

The proton image data 200 and 204 and the fluorine image data 206-216 are recorded in FIG. 2 in an alternating manner. Data acquisition of proton MR image data 200 is followed by three steps of data acquisition of fluorine MR image data 206-210. This is followed by the next step of proton image data acquisition leading to the ¹H MR image data 202. This again is followed by the ¹⁹F MR image data acquisition leading to the individual fluorine MR images 212-216, which is again followed by a ¹H MR image data acquisition leading finally to the ¹H MR image 204. The acquisition of the proton MR image data is thereby performed using optimum apparatus measurement parameters which might for example be the usage of a small voxel size in combination with a short acquisition period in order to avoid motion artefacts. In contrary, the acquisition of the fluorine MR image data is performed using optimum apparatus measurement parameters, for example a relatively large voxel size in order to keep the total imaging time within practical bounds due to a necessary chemical-shift direction of the acquisition.

The magnetic resonance imaging of the two different nuclei results in two magnetic resonance datasets, each of which is a time sequence of either unidimensional (linear) or multidimensional (planar, monometric, or spectroscopic) MRI data.

A motion estimation unit which is capable of tracking the motion of the depicted colon is used and analyzes the motion of the colon from the ¹H pictogram 200 to pictogram 202 to pictogram 204. Thereby, said estimator must at least be able to generate a motion estimate at a given time instance between two consecutive reference data acquisitions, that means in the present example ¹H MR data acquisitions.

By analysis of the proton MR image data 200 and 202, the motion estimation unit calculates a motion estimation 222, which can then be used to correct the ¹⁹F MR data 206-210 recorded in between the measurement of the proton datasets 200 and 202.

In the present example, by analysis of the ¹H MR image data 200 and 202 a motion trajectory 218 is calculated by the motion estimation unit. Similarly, by analysis of the proton MR image data 202 and 204 a motion estimation 224 is calculated by the motion estimation unit leading to a motion trajectory 220. The motion trajectory 220 can thereby be applied to the ¹⁹F MR image data 212 to 216.

As shown in FIG. 2b, the motion trajectory 218 can be used to calculate and project the ¹⁹F fluorine MR image data 206-210 to form a virtual ¹⁹F MR image 226. Since each of the ¹⁹F MR images 206-210 is individually corrected to an imaginary time instance, in the present example the time instance “5”, all corrected ¹⁹F MR images 206, 208 and 210 can be superimposed to form one combined ¹⁹F MR image 226. Even though, in the individual ¹⁹F MR images 206-210 the ¹⁹F labelled area appears only as a barely visible spot, the additive combined MR image 226 finally clearly shows said spot with a high signal to noise ratio. Since the fluorine MR data is projected to the time instance 5, where also the proton MR image 202 was recorded, the proton MR image 202 and the fluorine MR image 226 can be overlaid in order to form a combined MR image. Using that combined MR image, it is possible to easily spatially locate the spot in the total picture of the investigated colon.

In order to ensure a high quality of the motion estimation, a motion reliability unit is used in order to analyze the quality of the motion estimation and therewith the correctness of the calculated motion trajectories 218 and 220. If analysis of the motion estimation results in a certain uncertainty regarding a calculated motion trajectory, it is for example possible to change data acquisition parameters of the proton image data acquisition. This includes a further reduction of the used voxel size or a longer proton data accumulation process, which is an averaging process, whereby the signal to noise ratio increases with the square root of the number of averages. It is also possible to completely change the proton and fluorine imaging sequence shown in FIG. 2 in order to obtain more intermediate proton imaging steps or, in opposite to change certain imaging parameters in order to reduce the total data acquisition time. Reduction of data acquisition time can be especially achieved by faster averaging and less proton data acquisition steps, which might be suitable in case of non-moving or slow moving objects.

It has to be noted, that the motion prediction can be performed in an interpolating or extrapolating manner. Thereby, interpolating means that as shown in FIG. 2 proton MR image data acquisition is performed, followed by MR data acquisition of the second nucleus, followed again by proton MR data acquisition. The MR images resulting from the MR imaging process before and after the second nucleus imaging process are thereby used to calculate a motion trajectory of the imaged object in between said two imaging steps. In contrary, motion estimation in an extrapolating manner means, that the motion trajectory is predictive calculated by analysis of two subsequent proton MR image data acquisition steps and applied to MR imaging steps of the second nucleus, whereby the MR imaging steps of the second nucleus are following the proton MR imaging steps.

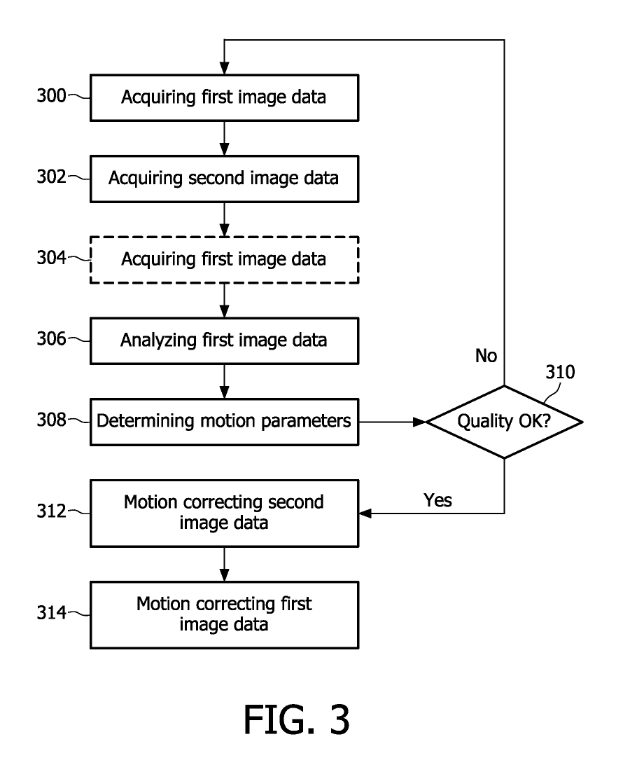

FIG. 3 shows a flowchart illustrating a method of motion correction MR image data. In step 300, first MR image data are acquired. This is followed by step 302 where second MR image data are acquired. Depending on the type of motion correction, i.e., in an interpolating or extrapolating manner, the optional step 304 is required which comprises again data acquisition of first MR image data. Step 302 or step 304 are then followed by step 306 which comprises analysis of the first MR image data acquired in step 300 and optionally step 304. In step 308 motion parameters are determined based on said analysis in step 306. In step 310 a motion reliability unit is used to assign a quality value to the motion estimation of step 308. If step 310 results that the quality of the calculated motion trajectory of the imaged object is not sufficient in order to perform an adequate motion correction of the acquired second image data, steps 300 to steps 308 are repeated with improved apparatus measurement parameters regarding the data acquisition of the first MR image data. If step 310 returns, that the reliability of the determined motion parameters are in an acceptable range, a motion correction of the second MR image data is performed in step 312. This is followed by a further motion correction, the motion correction of the first MR image data acquired in steps 300 and 304. Thereby the motion correction in step 312 and step 314 is performed by means of a reconstruction of the acquired MR image data at a given imaginary temporal instance, whereby the temporal instances for motion correcting of the first and the second MR image data are equal. This means, that the motion corrected first and second image data appear at matching (imaginary) spatial or volumetric locations.

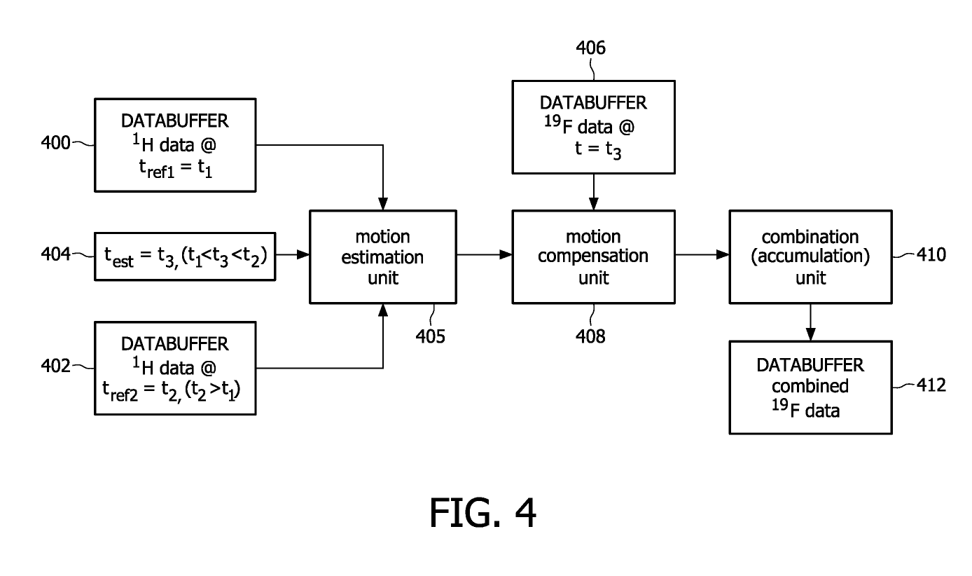

FIG. 4 shows a further detailed block diagram illustrating a system for motion correcting MR image data, here in an embodiment regarding first MR image data comprising ¹H data and second MR image data comprising ¹⁹F data. In a first step, ¹H data is acquired at a time instance t₁ and stored in a data buffer 400. This is followed by a ¹⁹F data acquisition at a time instance t₃, whereby said acquired ¹⁹F data is stored in a data buffer 406. This again is followed by another ¹H data acquisition step at a time instance t₂, whereby said acquired ¹H MR data is stored in a data buffer 402. Using the content of the data buffer 400 and the content of the data buffer 402, a motion estimation unit 405 estimates a motion of the image object at a time instance tₑₛₜ which is input to the motion estimation unit 405 by means of a predefined value 404. In the present example, t₁<tₑₛₜ=t₃<t₂. In general, the motion estimation unit 405 must at least be able to generate a motion estimate at a given time instance between two consecutive reference data acquisitions at time t₁ and time t₂ with t₂>t₁.

The motion estimation unit 405 calculates a motion trajectory which is input to a motion compensation unit 408. Also the content of the data buffer 406 is input to the motion compensation unit 408. Since typically the data comprised in the data buffer 406 comprises multiple sets of acquired ¹⁹F data for the purpose of data averaging, each individual set is motion compensated in the motion compensation unit 408 to appear at the given time instance t₃. All the motion compensated datasets are finally combined in the combination unit 410. Thereby, such a combination corresponds to an accumulation of ¹⁹F data which further corresponds to an averaging of said ¹⁹F data in order to obtain a high signal to noise ratio. Finally, the combined ¹⁹F data is put into a data buffer 412. Optionally and not shown here is a further motion compensation of the ¹H data comprised in the data buffers 400 and 402 to also appear at the given time instance t₃. Such a motion compensation is suitable in order to overlay the combined ¹⁹F data comprised in the data buffer 412 with respective ¹H data in order to obtain an overall localization of the objects appearing in the ¹⁹F MR images with respect to the surrounding proton containing structures.

### LIST OF REFERENCE NUMERALS

| | |
|---|---|
| 100 | Data processing system |
| 102 | Screen |
| 104 | Input device |
| 106 | Memory |
| 108 | Interface |
| 110 | Processors |
| 112 | Computer program product |
| 114 | Module |
| 116 | Module |
| 118 | Module |
| 120 | Module |
| 122 | Main magnets |
| 124 | Gradient coils |
| 126 | Body |
| 128 | RF coil |
| 130 | Main field control unit |
| 132 | Gradient coils control unit |
| 134 | RF coil control unit |
| 136 | Amplifier |
| 138 | Generator |
| 200 | ¹H image data |
| 202 | ¹H image data |
| 204 | ¹H image data |
| 206 | ¹⁹F image data |
| 208 | ¹⁹F image data |
| 210 | ¹⁹F image data |
| 212 | ¹⁹F image data |
| 214 | ¹⁹F image data |
| 216 | ¹⁹F image data |
| 218 | Motion trajectory |
| 220 | Motion trajectory |
| 222 | Motion estimation |
| 224 | Motion estimation |
| 226 | Calculated ¹⁹F image data |
| 400 | Data buffer |
| 402 | Data buffer |
| 404 | Predetermined value |
| 405 | Motion estimation unit |
| 406 | Data buffer |
| 408 | Motion compensation unit |
| 410 | Combination unit |
| 412 | Data buffer |

1. A method for acquiring MR images of an object, said object comprising at least first and second kinds of nuclei, the method comprising:
acquiring first MR image data of the object, wherein the first nuclei are excited,
acquiring second MR image data of the object, wherein the second nuclei are excited,
analyzing the first MR image data
determining motion parameters describing a motion of the object based on said analysis,
motion correcting the first and/or second MR image data using said motion parameters.

2. The method of claim 1, wherein the excitation of the first and second nuclei is performed simultaneously.

3. The method of claim 1, wherein the excitation of the first nuclei is performed alternating with the excitation of the second nuclei.

4. The method of claim 3, wherein the acquisition of the first MR image data is performed using optimum apparatus measurement parameters and wherein the acquisition of the second MR image data is performed using optimum apparatus measurement parameters.

5. The method of claim 1, wherein the motion parameters describe the motion of the object during the acquisition of the first and/or the second MR image data.

6. The method of claim 1, wherein the motion parameters describe an estimated motion of the object after the acquisition of the first and/or the second MR image data.

7. The method of claim 1, further comprising determining a quality measure, wherein the quality measure is a value describing the reliability of the determined motion parameters.

8. The method of claim 7, wherein based on the quality measure the acquisition time for acquiring of the first MR image data is determined.

9. The method of claim 1, wherein the first and/or the second MR image data is unidimensional or multidimensional MRI data.

10. The method of claim 3, wherein acquiring the first MR image data comprises a first and a second data acquisition step, wherein the acquisition of the second MR image data is performed in between the first and the second data acquisition step.

11. The method of claim 3, wherein the motion correction of the first MR image data is performed relative to the object position at a first point in time and wherein the motion correction of the second MR image data is performed relative to the object position at a second point in time, wherein the first and the second point in time are substantially identical.

12. The method of claim 1, wherein the first kinds of nuclei comprise ¹H nuclei and the second kinds of nuclei comprise ²H or ¹³C or ¹⁴N or ¹⁷O ¹⁹F or ²³Na or ³⁹K or ³¹P nuclei.

13. The method of claim 1, wherein analyzing the first MR image data for determining the motion parameters describing a motion of the object is performed using a block-matching algorithm and/or a phase plane algorithm and/or an optical flow calculation algorithm.

14. The method of claim 1, wherein acquiring of the first MR image data and/or acquiring of the second MR image data comprises multiple data acquisitions.

15. The method of claim 1, wherein the acquisition of the first MR image data is performed using a first RF coil tuned to a first Larmor frequency corresponding to the first kinds of nuclei and a wherein the acquisition of the second MR image data is performed using a second RF coil tuned to a second Larmor frequency corresponding to the second kinds of nuclei.

16. The method of claim 1, wherein the acquisition of the first MR image data and acquisition of the second MR image data is performed using the first RF coil, wherein the first RF coil is tuned to the first and the second Larmor frequency of the first and the second kinds of nuclei, respectively or wherein the first RF coil is a dual-tuned coil which is at the same time resonant at the first and the second Larmor frequency of the first and the second kinds of nuclei, respectively.

17. The method of claim 1, further comprising correcting a chemical-shift of the first and/or second MR image data.

18. A magnetic resonance imaging apparatus for acquiring MR images of an object, said object comprising at least first and second kinds of nuclei, the apparatus comprising:
components for acquiring first MR image data of the object,
components for acquiring second MR image data of the object,
components for analyzing the first MR image data, said components for analyzing the first MR image data being adapted for determining motion parameters describing a motion of the object,
components for motion correcting the first and/or second MR image data using said motion parameters.

19. The apparatus of claim 18, further comprising components for determining a quality measure, wherein the quality measure is a value describing the reliability of the determined parameters.

20. The apparatus of claim 18, further comprising components for correcting a chemical-shift of the first and/or second MR image data.

21. The apparatus of claim 18, wherein the components for acquiring the first MR image data comprise a first RF coil being tuneable to a first Larmor frequency corresponding to the first kinds of nuclei and wherein the components for acquiring the second MR image data comprise a second RF coil being tuneable to a second Larmor frequency corresponding to the second kinds of nuclei.

22. The apparatus of claim 18, wherein the components for acquiring the first MR image data and the components for acquiring the second MR image data comprise the first RF coil, whereby the first RF coil is tuneable to the first and the second Larmor frequency of the first and the second kinds of nuclei, respectively or wherein the first RF coil is a dual-tuned coil which is at the same time resonant at the first and the second Larmor frequency of the first and the second kinds of nuclei, respectively.

23. A computer program product comprising computer executable instructions for performing the method steps of claim 1.
